(19) United States
(12) Patent Application Publication
(10) Pub. No.: US 2014/0076558 A1
(43) Pub. Date: Mar. 20, 2014

(54) Methods and Compositions for Treating Proppant to Prevent Flow-Back

(71) Applicants: Philip D. Nguyen, Houston, TX (US); Jimmie D. Weaver, Duncan, OK (US)

(72) Inventors: Philip D. Nguyen, Houston, TX (US); Jimmie D. Weaver, Duncan, OK (US)

(73) Assignee: Halliburton Energy Services, Inc., Houston, TX (US)

(21) Appl. No.: 13/621,908

(22) Filed: Sep. 18, 2012

(51) Int. Cl. E21B 43/267; C09K 8/80

(52) U.S. Cl. 166/280.2; 166/280.1

(57) ABSTRACT

Methods of consolidating proppant particulates in a subterranean formation comprising providing a proppant slurry comprising a carrier fluid, proppant particulates, and a curable resin composition. The curable resin composition comprises a solid curable resin particulate, a curing agent, and a silane coupling agent. The proppant slurry is introduced into a fracture within a subterranean formation and thereafter solid curable resin particulate softens so as to coat the proppant particulates and then is cured so as to consolidate the proppant particulates into a permeable proppant pack.

### BACKGROUND

The present invention relates to fracturing operations and, more particularly, to methods of consolidating proppant particulates in a subterranean formation.

Hydrocarbon producing wells can be stimulated using fracturing treatments. In a typical hydraulic fracturing treatment, a fracturing fluid is pumped through a wellbore and into a subterranean formation producing zone at a rate and pressure such that one or more fractures are formed or extended in the zone. The fracturing fluid may also function as a carrier fluid that transports solids to a target area. For example, particulate solids (e.g., graded sand), or “proppant particulates,” may be suspended in a portion of the fracturing fluid and transported to a fracture. The fracturing fluid can then be removed, leaving behind a deposit of proppant particulates. The deposited proppant particulates act to prop the fracture after the hydraulic pressure is removed so that conductive channels are formed through which produced hydrocarbons can readily flow.

In order to prevent flowback of proppant particulates, as well as loose or unconsolidated sand or formation fines, from the fracture and into the wellbore, a portion of the proppant particulates introduced into the fracture may be coated with a hardenable resin composition. The hardenable resin composition can consolidate various particulate solids that are present in the zone. Traditionally, liquid hardenable resin compositions are used to coat proppant particulates. When the fracturing fluid, which acts as a carrier fluid, is removed, the resin-coated proppant particulates remain in the fracture and form a barrier that abuts the fracture faces. Thus, when the fracture closes, the resin-coated proppant particulates interact with the other solid particulates and become consolidated masses once the resin composition hardens.

There are several issues that can limit the usefulness of conventional hardenable resin compositions. Liquid hardenable resin compositions often have a very short shelf life (i.e., as short as four hours or less, especially for low-temperature compositions that become highly viscous and non-pumpable quickly after their preparation) and a low flash point that can make them impractical for certain uses. In addition, liquid hardenable resin compositions introduced into a wellbore may experience friction forces downhole that prevent a sufficient concentration of the hardenable resin composition from coating the proppant particulates within a fracture. This may cause the proppant particulates to loosely pack together and flow back into the wellbore even after hydraulic pressure is removed, compromising fracture conductivity.

Moreover, flowback of solid particulates, as well as the use of liquid hardenable resin compositions, causes wear on fracturing and production equipment and requires resources in the form labor and time to clean and maintain the equipment in order to minimize such wear. This is particularly true in operations using silo gravity feeders that add proppant particulates directly to fracturing fluids prior to pumping downhole, and which are becoming more prevalent in the industry. Therefore, a practical method of reducing proppant flowback that overcomes these potential downfalls may be of value to one of ordinary skill in the art.

### SUMMARY OF THE INVENTION

The present invention relates to fracturing operations and, more particularly, to methods of consolidating proppant particulates in a subterranean formation.

In some embodiments, the present invention provides a method comprising providing a proppant slurry comprising a carrier fluid, proppant particulates, and a curable resin composition comprising a solid curable resin particulate, a curing agent, and a silane coupling agent; introducing the proppant slurry into a fracture within a subterranean formation; and melting the solid curable resin particulate so as to coat and consolidate the proppant particulates into a permeable proppant pack.

In other embodiments, the present invention provides a method comprising introducing proppant particulates to a carrier fluid while the carrier fluid is mixed to form a proppant slurry; introducing a curing agent and a silane coupling agent to the proppant slurry; introducing a solid curable resin particulate to the proppant slurry; introducing the proppant slurry into a fracture within a subterranean formation; and allowing the solid curable resin particulate to melt so as to coat and consolidate the proppant particulates into a permeable proppant pack.

The features and advantages of the present invention will be readily apparent to those skilled in the art upon a reading of the description of the preferred embodiments that follows.

### DETAILED DESCRIPTION

The present invention relates to fracturing operations and, more particularly, to methods of consolidating proppant particulates in a subterranean formation.

The present invention provides methods for treating proppant particulates with solid curable resin particulates to form a permeable consolidated proppant pack. The proppant pack can be used to prop a fracture in a subterranean formation. In some embodiments, the present invention may prevent proppant flowback and consolidate loose solid particulates (e.g., proppant particulates, sands, formation fines, and the like) present in the formation.

In certain methods of the present invention, proppant particulates are mixed in a carrier fluid with a solid curable resin particulate, a curing agent, and a silane coupling agent to form a proppant slurry. The curing agent may be a liquid that facilitates adhesion of the solid curable resin particulate to the proppant particulates. In some embodiments, the proppant slurry can be introduced downhole where consolidation of the proppant particulates into a proppant pack can take place. As used herein, “proppant pack,” refers to an agglomeration of proppant particulates. In some embodiments, consolidation of the proppant particulates into proppant packs can form a hard permeable mass having sufficient compressive and tensile strength to prevent unconsolidated proppant and formation sand from flowing out of a fracture with treatment or produced fluids. In other embodiments, a tackifying agent may also be used such that the after the resin cures, the resin-coated proppant particulates exhibit a tacky quality which facilitates proppant pack formation to reduce flowback and enhance formation conductivity. As used herein, the term “tacky,” in all of its forms, generally refers to a substance having a nature such that it is (or may be activated to become) somewhat sticky to the touch.

Traditional consolidation techniques often involve mixing proppant particulates with a liquid hardenable resin. However, liquid hardenable resins can easily contaminate parts and equipments used during storage, transport, and injection of proppant particulates. Moreover, liquid hardenable resins can have a very short shelf life and may not effectively aid in proppant pack formation due to frictional forces within a formation. One approach that potentially addresses some of the issues associated with liquid hardenable resins is to mix proppant particulates and liquid hardenable resins just prior to introducing the resultant proppant slurry downhole. The use of liquid hardenable resins may become additionally increasingly unpractical as more operators switch from, for example, sand screw feeders to silo gravity feeders as a means of delivering proppant from an on-site storage container into a fracturing fluid during the mixing process. Methods of mixing proppant slurry using a sand screw feeder are described in U.S. Pat. No. 6,962,200, the entire disclosure of which is hereby incorporated by reference. Unlike sand scew feeders, which may coat proppant particulates with liquid hardenable resin prior to placing the composition in fracturing or carrier fluid, silo gravity feeders add uncoated proppant particulates directly into the fracturing or carrier fluid along with resin compositions.

I. Proppant Slurry

According to one or more embodiments, the present invention provides a proppant slurry comprising a carrier fluid, proppant particulates, and a curable resin composition. The curable resin composition may comprise a solid curable resin particulate, a curing agent, and a silane coupling agent. The proppant slurry may be prepared by any suitable means known in the art. In some embodiments, the proppant slurry may be formed or mixed by separately adding the various components (i.e., proppant particulates, solid curable resin particulate, curing agent, etc.) of the slurry.

In one embodiment of the present invention, the proppant particulates may be introduced into a slurry mixer containing the carrier fluid. Next, the curing agent (e.g., a tackifying agent or a resin curing agent) may be introduced into the slurry mixer as the slurry is being mixed. Next, the solid curable resin particulate may be introduced into the slurry mixer. According to some embodiments, the solid curable resin particulate may be introduced into the slurry mixer by a gravity-feeder or a similar device. The proppant slurry may be prepared by any suitable mixing means such as, for example, batch mixing or continuous mixing.

Generally, the proppant slurry may be introduced downhole into a fracture within a subterranean formation. Once the solid curable resin particulates and the proppant particles are placed into a fracture within a subterranean formation, they are exposed to the temperatures of the downhole environment as well as increased pressure once the fracturing pressure is released. This exposure to environmental forces may cause the solid curable resin particulates to soften, and they may even melt, or flow so as to cover at least a portion of the proppant particles. In cases where the solid curable resin particulates do not soften to the point of flowing, they will nonetheless be pressed in close contact with the adjacent proppant particulates in a manner sufficient to adhere the proppant to the resin.

A. Curable Resin Composition

1. Solid Curable Resin Particulates

Any number of solid curable resin particulates may be used in accordance with the present invention. In typical methods, liquid hardenable resins are used as consolidating agents. For example, a two-component epoxy-based resin may comprise a liquid hardenable resin component and a liquid hardening agent component, which when combined under appropriate conditions create a solid curable resin particulate. By contrast, the present invention provides solid curable resin particulates that may be used as consolidating agents without the need for a liquid hardenable resin.

In some embodiments, the solid curable resin particulate may comprise an epoxy resin selected from the group consisting of a diglycidyl ether of bisphenol A, a diglycidyl ether of bisphenol F, a novolak epoxy, a polyepoxide resin, a phenol-aldehyde resin, a urea-aldehyde resin, a urethane resin, a phenolic resin, a furan resin, a furan/fufuryl alcohol resin, a urea-aldehyde resin, a phenol formaldehyde resin, a hybrid of a polyester resin, a copolymer of a polyester resin, a polyurethane resin, a hybrid of a polyurethane resin, a copolymer of a polyurethane resin, an acrylate resin, any derivative thereof, and any combination thereof.

The solid curable resin particulates may have any shape, size, and concentration to achieve the desired results, consistent with this disclosure. Suitable shapes include, but are not limited to, granular, ribbon, flake, powder, fiber and combinations thereof. In some embodiments, the solid curable resin particulates may be about 0.001 millimeters (mm) to about 3 mm in diameter. In some embodiments, the solid curable resin particulate may be present in an amount of about 0.1% to about 5% (w/w) of the proppant particulates. In preferred embodiments, the solid curable resin particulate may be present in an amount of about 0.5% to about 2% (w/w) of the proppant particulates. The shape, size, and concentration of solid curable resin particulates for a particular application may depend, among other things, on the type and porosity of the subterranean formation, downhole temperatures, downhole pressures, treatment fluid types, and the like. It is within the ability of one skilled in the art, with the benefit of this disclosure, to determine the shape, size, and concentration of solid curable resin particulates to include in the methods of the present invention to achieve the desired results.

2. Curing Agent

Any number of curing agents may be used in accordance with one or more embodiments of the present invention so long as it is able to cure the selected resin. In some embodiments, the curing agent is selected from the group consisting of a tackifying compound, a liquid resin curing agent, and any combination thereof. One of skill in the art will recognize that the selected curing agent must be matched with the selected curable resin. By way of example, where an epoxy resin is used, the selected curing agent may be a tackifying compound that contains amine or amide reaction sites that are capable of initiating the cure of the solid epoxy resin particle.

Suitable tackifying compounds may be selected from the group consisting of a non-aqueous tackifying agent, an aqueous tackifying agent, a silyl-modified polyamide, a zeta potential modifying agent, any derivative thereof, and any combination thereof. Nonlimiting examples of suitable non-aqueous tackifying agents may be found in U.S. Pat. Nos. 5,853,048 entitled “Control of Fine Particulate Flowback in Subterranean Wells,” 5,839,510 entitled “Control of Particulate Flowback in Subterranean Wells,” and 5,833,000 entitled “Control of Particulate Flowback in Subterranean Wells,” and U.S. Patent Application Publication Nos. 2007/0131425 entitled “Aggregating Reagents, Modified Particulate Metal-Oxides, and Methods for Making and Using Same” and 2007/0131422 entitled “Sand Aggregating Reagents, Modified Sands, and Methods for Making and Using Same,” the entire disclosures of which are herein incorporated by reference. A particularly preferred group of non-aqueous tackifying agents comprises polyamides that are liquids or in solution at the temperature of the subterranean formation such that they are, by themselves, nonhardening when introduced into the subterranean formation. A particularly preferred product is a condensation reaction product comprised of a commercially available polyacid and a polyamine. Such commercial products include compounds such as combinations of dibasic acids containing some trimer and higher oligomers and also small amounts of monomer acids that are reacted with polyamines. Other polyacids include trimer acids, synthetic acids produced from fatty acids, maleic anhydride, acrylic acid, and the like. Combinations of these may be suitable as well. Nonlimiting examples of suitable aqueous tackifying agents may be found in U.S. Pat. Nos. 5,249,627 entitled “Method for Stimulating Methane Production from Coal Seams” and 4,670,501 entitled “Polymeric Compositions and Methods of Using Them,” and U.S. Patent Application Publication Nos. 2005/0277554 entitled “Aqueous Tackifier and Methods of Controlling Particulates” and 2005/0274517 entitled “Aqueous-Based Tackifier Fluids and Methods of Use,” the entire disclosures of which are herein incorporated by reference. Nonlimiting examples of suitable silyl-modified polyamide compounds may be found in U.S. Pat. No. 6,439,309 entitled “Compositions and Methods for Controlling Particulate Movement in Wellbores and Subterranean Formations,” the entire disclosure of which is herein ncorporated by reference. Nonlimiting examples of suitable zeta-potential modifying aggregating compositions may be found in U.S. Pat. Nos. 7,956,017 entitled “Aggregating Reagents, Modified Particulate Metal-Oxides and Proppant particulates” and 7,392,847 entitled “Aggregating Reagents, Modified Particulate Metal-Oxides, and Methods for Making and Using Same,” the entire disclosures of which are herein incorporated by reference. It is within the ability of one skilled in the art, with the benefit of this disclosure, to determine the type and amount of tackifying compound to include in the methods of the present invention to achieve the desired results. In some embodiments, the tackifying compound is present from about 0.1% to about 5% (w/w) of the solid curable resin particulates. In preferred embodiments, the tackifying compound is present in an amount of about 0.5% to about 2% (w/w) of the solid curable resin particulates. It is within the ability of one skilled in the art, with the benefit of this disclosure, to determine the concentration of tackifying compound to include in the methods of the present invention to achieve the desired results.

Suitable liquid resin curing agents may be selected from the group consisting of: an amine; a polyamine; an amide; a polyamide; an aromatic amine; 4,4′-diaminodiphenyl sulfone; an aliphatic amine; a cyclo-aliphatic amine; piperazine; piperidine; triethylamine; benzyldimethylamine; N,N-dimethyladminopyridine; 2-N₂N-dimethylaminomethyl)phenol; tris(dimethylaminomethyl)phenol; ethylene diamine; diethylene triamine; methylene dianiline; triethylene tetraamine; tetraethylene pentaamine; imidazole; pyrazole; pyrazine; pyrimidine; pyridazine; purine; phthalazine; naphthyridine; quinoxaline; quinazoline; phenazine; 1H-indazole; imidazolidine; cinnoline; imidazoline; 1,3,5-triazine; thiazole; pteridine; indazole; 2-ethyl-4-methyl imidazole; any derivative thereof; and any combination thereof.

In some embodiments, the liquid resin curing agent may further comprise a hydrolyzable ester selected from the group consisting of dimethylglutarate, dimethyladipate, dimethylsuccinate, sorbitol, catechol, dimethylthiolate, methyl salicylate, dimethyl salicylate, dimethylsuccinate, terbutylhydroperoxide, any derivative thereof, and any combination thereof. In some embodiments, the liquid curing agent may be present in the amount of about 0.1% to about 5% (w/w) of the solid curable resin particulates. It is within the ability of one skilled in the art, with the benefit of this disclosure, to determine the concentration of liquid curing agent to include in the methods of the present invention to achieve the desired results.

The chosen liquid resin curing agent often effects the range of temperatures over which a hardenable resin is able to cure. By way of example, and not of limitation, in subterranean formations having a temperature of about 60° F. to about 250° F., amines and cyclo-aliphatic amines such as piperidine, triethylamine, tris(dimethylaminomethyl)phenol, and dimethylaminomethyl)phenol may be preferred. In subterranean formations having higher temperatures, 4,4′-diaminodiphenyl sulfone may be a suitable hardening agent. Hardening agents that comprise piperazine or a derivative of piperazine have been shown capable of curing various hardenable resins from temperatures as low as about 50° F. to as high as about 350° F. In some embodiments, the hardening agent may be present in the amount of about 0.1% to about 5% (w/w) of the solid curable resin particulates. It is within the ability of one skilled in the art, with the benefit of this disclosure, to determine the concentration of hardening agent to include in the methods of the present invention to achieve the desired results.

3. Silane Coupling Agent

The silane coupling agent may be used, among other things, to act as a mediator to help bond the resin to formation particulates or proppant particulates.

Generally, any suitable silane coupling agent may be used in accordance with particular embodiments of the present invention. Examples of suitable silane coupling agents include, but are not limited to, N-2-(aminoethyl)-3-aminopropyltrimethoxysilane; 3-glycidoxypropyltrimethoxysilane; gamma-aminopropyltriethoxysilane; N-beta-(aminoethyl)-gamma-aminopropyltrimethoxysilanes; aminoethyl-N-beta-(aminoethyl)-gamma-aminopropyl-trimethoxysilanes; gamma-ureidopropyl-triethoxysilanes; beta-(3-4 epoxy-cyclohexyl)-ethyl-trimethoxysilane; gamma-glycidoxypropyltrimethoxysilanes; vinyltrichlorosilane; vinyltris (beta-methoxyethoxy)silane; vinyltriethoxysilane; vinyltrimethoxysilane; 3-metacryloxypropyltrimethoxysilane; beta-(3,4 epoxycyclohexyl)-ethyltrimethoxysilane; r-glycidoxypropyltrimethoxysilane; r-glycidoxypropylmethylidiethoxysilane; N-beta-(aminoethyl)-r-aminopropyl-trimethoxysilane; N-beta-(aminoethyl)-r-aminopropylmethyldimethoxysilane; 3-aminopropyl-triethoxysilane; N-phenyl-r-aminopropyltrimethoxysilane; r-mercaptopropyltrimethoxysilane; r-chloropropyltrimethoxysilane; vinyltris(beta-methoxyethoxy)silane; r-metacryloxypropyltrimethoxysilane; beta-(3,4 epoxycyclohexyl)-ethyltrimethoxysila; r-glycidoxypropyltrimethoxysilane; r-glycidoxypropylmethylidiethoxysilane; N-beta-(aminoethyl)-r-aminopropyltrimethoxysilane; N-beta-(aminoethyl)-r-aminopropylmethyldimethoxysilane; r-aminopropyltriethoxysilane; N-[3-(trimethoxysilyl)propyl]-ethylenediamine; and combinations thereof. In some embodiments, the silane coupling agent may be present in the curable adhesive composition in an amount from about 0.1% to about 5% by weight of the composition, and preferably in an amount from about 0.5% to about 3% by weight of the composition. In other embodiments of the present invention, the silane coupling agent used is in the amount of about 0.05% to about 0.2% (w/w) of the proppant particulates.

B. Proppant Particulates

Proppant particulates suitable for use in the methods of the present invention may be of any size and shape combination known in the art as suitable for use in a fracturing operation. Generally, where the chosen proppant is substantially spherical, suitable proppant particulates have a size in the range of from about 2 to about 400 mesh, U.S. Sieve Series. In some embodiments of the present invention, the proppant particulates have a size in the range of from about 8 to about 120 mesh, U.S. Sieve Series.

The present invention provides for both high-density proppant particulates and low-density proppant particulates. High-density proppant particulates are characterized by an average density of 1.50 g/cm³ or higher. In some embodiments, the average density is 2.00 g/cm³ or greater. In some embodiments, the average density is 2.50 g/cm³ or greater. Low-density proppant particulates are characterized by an average density of less than 1.50 g/cm³ and preferably less than 1.25 g/cm³ and most preferably 1.00 g/cm³ or less. In some embodiments, the average density is 0.85 g/cm³ or less. In some embodiments, the average density is 0.75 g/cm³ or less. The exact value of average density may depend on a number of factors including, but not limited to, the carrier fluid used, the number of different proppant particulates used, and the like. In some embodiments, the proppant particulates may have a fairly narrow distribution of density. In other embodiments, the proppant particulates may have a fairly wide distribution of density.

In some embodiments of the present invention it may be desirable to use substantially non-spherical proppant particulates. Suitable substantially non-spherical proppant particulates may be cubic, polygonal, fibrous, or any other non-spherical shape. Such substantially non-spherical proppant particulates may be, for example, cubic-shaped, rectangular-shaped, rod-shaped, ellipse-shaped, cone-shaped, pyramid-shaped, or cylinder-shaped. That is, in embodiments wherein the proppant particulates are substantially non-spherical, the aspect ratio of the material may range such that the material is fibrous to such that it is cubic, octagonal, or any other configuration. Substantially non-spherical proppant particulates are generally sized such that the longest axis is from about 0.02 inches to about 0.3 inches in length. In other embodiments, the longest axis is from about 0.05 inches to about 0.2 inches in length. In one embodiment, the substantially non-spherical proppant particulates are cylindrical having an aspect ratio of about 1.5 to 1 and about 0.08 inches in diameter and about 0.12 inches in length. In another embodiment, the substantially non-spherical proppant particulates are cubic having sides about 0.08 inches in length. The use of substantially non-spherical proppant particulates may be desirable in some embodiments of the present invention because, among other things, they may provide a lower rate of settling when slurried into a fluid as is often done to transport proppant particulates to desired locations within subterranean formations. By so resisting settling, substantially non-spherical proppant particulates may provide improved proppant particulate distribution as compared to more spherical proppant particulates.

Proppant particulates suitable for use in the present invention may comprise any material suitable for use in subterranean operations. Suitable materials for these proppant particulates include, but are not limited to, sand, bauxite, ceramic materials, glass materials, polymer materials (such as EVA or composite materials), polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof. Suitable composite particulates may comprise a binder and a filler material wherein suitable filler materials include silica, alumina, fumed carbon, carbon black, graphite, mica, titanium dioxide, barite, meta-silicate, calcium silicate, kaolin, talc, zirconia, boron, fly ash, hollow glass microspheres, solid glass, and combinations thereof. Suitable proppant particles for use in conjunction with the present invention may be any known shape of material, including substantially spherical materials, fibrous materials, polygonal materials (such as cubic materials), and combinations thereof.

C. Carrier Fluid

Any suitable carrier fluid that may be employed in subterranean operations may be used in accordance with the teachings of the present invention, including aqueous gels, viscoelastic surfactant gels, oil gels, foamed gels, and emulsions, and combinations thereof. Suitable aqueous gels are generally comprised of water and one or more gelling agents. Suitable emulsions can be comprised of two immiscible liquids such as an aqueous liquid or gelled liquid and a hydrocarbon. Foams can be created by the addition of a gas, such as carbon dioxide or nitrogen. In exemplary embodiments of the present invention, the carrier fluids are aqueous gels comprised of water, a gelling agent for gelling the water and increasing its viscosity, and, optionally, a crosslinking agent for crosslinking the gel and further increasing the viscosity of the fluid. The increased viscosity of the gelled, or gelled and cross-linked, carrier fluid, inter alia, reduces fluid loss and allows the carrier fluid to transport proppant particulates (where desired) and/or the proppant aggregates (if necessary). The water used to form the carrier fluid may be fresh water, saltwater, seawater, brine, or any other aqueous liquid that does not adversely react with the other components. The density of the water can be increased to provide additional particle transport and suspension in the present invention.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
providing a proppant slurry comprising a carrier fluid, proppant particulates, and a curable resin composition comprising a solid curable resin particulate, a curing agent, and a silane coupling agent;
introducing the proppant slurry into a fracture within a subterranean formation;
softening the solid curable resin particulate so that the softened resin coats at least a portion of the proppant particulates; and,
curing the resin with the curing agent to form a consolidated, permeable proppant pack.

2. The method of claim 1, wherein the proppant slurry is formed by batch mixing or continuous mixing.

3. The method of claim 0, wherein a gravity feeder feeds the proppant particulates into the proppant slurry during mixing.

4. The method of claim 0, wherein the curable resin composition is metered into the proppant slurry during mixing.

5. The method of claim 1, wherein the solid curable resin particulate comprises an epoxy resin selected from the group consisting of a diglycidyl ether of bisphenol A, a diglycidyl ether of bisphenol F, a novolak epoxy, a polyepoxide resin, a phenol-aldehyde resin, a urea-aldehyde resin, a urethane resin, a phenolic resin, a furan resin, a furan/fufuryl alcohol resin, a urea-aldehyde resin, a phenol formaldehyde resin, a hybrid of a polyester resin, a copolymer of a polyester resin, a polyurethane resin, a hybrid of a polyurethane resin, a copolymer of a polyurethane resin, an acrylate resin, any derivative thereof, and any combination thereof.

6. The method of claim 1, wherein the curing agent is a tackifying compound, a liquid resin curing agent, or a combination thereof.

7. The method of claim 6, wherein the tackifying compound is selected from the group consisting of a non-aqueous tackifying agent, an aqueous tackifying agent, a silyl-modified polyamide, a zeta potential modifying agent, any derivative thereof, and any combination thereof.

8. The method of claim 6, wherein the liquid resin curing agent is selected from the group consisting of: an amine; a polyamine; an amide; a polyamide; an aromatic amine; 4,4′-diaminodiphenyl sulfone; an aliphatic amine; a cyclo-aliphatic amine; piperazine; piperidine; triethylamine; benzyldimethylamine; N,N-dimethyladminopyridine; 2-N2N-dimethylaminomethyl)phenol; tris(dimethylaminomethyl)phenol; ethylene diamine; diethylene triamine; methylene dianiline; triethylene tetraamine; tetraethylene pentaamine; imidazole; pyrazole; pyrazine; pyrimidine; pyridazine; purine; phthalazine; naphthyridine; quinoxaline; quinazoline; phenazine; 1H-indazole; imidazolidine; cinnoline; imidazoline; 1,3,5-triazine; thiazole; pteridine; indazole; 2-ethyl-4-methyl imidazole; any derivative thereof; and any combination thereof.

9. The method of claim 8, wherein the liquid resin curing agent further comprises a hydrolyzable ester selected from the group consisting of dimethylglutarate, dimethyladipate, dimethylsuccinate, sorbitol, catechol, dimethylthiolate, methyl salicylate, dimethyl salicylate, dimethylsuccinate, terbutylhydroperoxide, any derivative thereof, and any combination thereof.

10. The method of claim 1, wherein the silane coupling agent is selected from the group consisting of N-2-(aminoethyl)-3-aminopropyltrimethoxysilane; 3-glycidoxypropyltrimethoxysilane; gamma-aminopropyltriethoxysilane; N-beta-(aminoethyl)-gamma-aminopropyltrimethoxysilanes; aminoethyl-N-beta-(aminoethyl)-gamma-aminopropyl-trimethoxysilanes; gamma-ureidopropyl-triethoxysilanes; beta-(3-4 epoxy-cyclohexyl)-ethyl-trimethoxysilane; gamma-glycidoxypropyltrimethoxysilanes; vinyltrichlorosilane; vinyltris(beta-methoxyethoxy)silane; vinyltriethoxysilane; vinyltrimethoxysilane; 3-metacryloxypropyltrimethoxysilane; beta-(3,4 epoxycyclohexyl)-ethyltrimethoxysilane; r-glycidoxypropyltrimethoxysilane; r-glycidoxypropylmethylidiethoxysilane; N-beta-(aminoethyl)-r-aminopropyl-trimethoxysilane; N-beta-(aminoethyl)-r-aminopropylmethyldimethoxysilane; 3-aminopropyl-triethoxysilane; N-phenyl-r-aminopropyltrimethoxysilane; r-mercaptopropyltrimethoxysilane; r-chloropropyltrimethoxysilane; vinyltris(beta-methoxyethoxy)silane; r-metacryloxypropyltrimethoxysilane; beta-(3,4 epoxycyclohexylyethyltrimethoxysila; r-glycidoxypropyltrimethoxysilane; r-glycidoxypropylmethylidiethoxysilane; N-beta-(aminoethyl)-r-aminopropyltrimethoxysilane; N-beta-(aminoethyl)-r-aminopropylmethyldimethoxysilane; r-aminopropyltriethoxysilane; N-[3-(trimethoxysilyl)propyl]-ethylenediamine; and combinations thereof.

11. A method comprising:
introducing proppant particulates to a carrier fluid while the carrier fluid is mixed to form a proppant slurry;
introducing a curing agent and a silane coupling agent to the proppant slurry;
introducing a solid curable resin particulate to the proppant slurry;
introducing the proppant slurry into a fracture within a subterranean formation; and
softening the solid curable resin particulate so that the softened resin coats at least a portion of the proppant particulates; and,
curing the resin with the curing agent to form a consolidated, permeable proppant pack.

12. The method of claim 11, wherein the proppant slurry is formed by batch mixing or continuous mixing.

13. The method of claim 11, wherein a gravity feeder feeds the proppant particulates into the carrier fluid during mixing.

14. The method of claim 11, wherein the carrier fluid is selected from the group consisting of a crosslinked gel, an aqueous gel, a viscoelastic surfactant gel, an oil gel, a foamed gel, an emulsion, and any combination thereof.

15. The method of claim 11, wherein the solid curable resin particulate has a form selected from the group consisting of granular, ribbon, flake, powder, fiber, and any combination thereof.

16. The method of claim 11, wherein the solid curable resin particulate comprises an epoxy resin selected from the group consisting of a diglycidyl ether of bisphenol A, a diglycidyl ether of bisphenol F, a novolak epoxy, a polyepoxide resin, a phenol-aldehyde resin, a urea-aldehyde resin, a urethane resin, a phenolic resin, a furan resin, a furan/fufuryl alcohol resin, a urea-aldehyde resin, a phenol formaldehyde resin, a hybrid of a polyester resin, a copolymer of a polyester resin, a polyurethane resin, a hybrid of a polyurethane resin, a copolymer of a polyurethane resin, an acrylate resin, any derivative thereof, and any combination thereof.

17. The method of claim 11, wherein the curing agent is a tackifying compound, a liquid resin curing agent, or a combination thereof.

18. The method of claim 17, wherein the tackifying compound is selected from the group consisting of a non-aqueous tackifying agent, an aqueous tackifying agent, a silyl-modified polyamide, a zeta potential modifying agent, any derivative thereof, and any combination thereof.

19. The method of claim 17, wherein the liquid resin curing agent is selected from the group consisting of: an amine; a polyamine; an amide; a polyamide; an aromatic amine; 4,4′-diaminodiphenyl sulfone; an aliphatic amine; a cyclo-aliphatic amine; piperazine; piperidine; triethylamine; benzyldimethylamine; N,N-dimethyladminopyridine; 2-N2N-dimethylaminomethyl)phenol; tris(dimethylaminomethyl)phenol; ethylene diamine; diethylene triamine; methylene dianiline; triethylene tetraamine; tetraethylene pentaamine; imidazole; pyrazole; pyrazine; pyrimidine; pyridazine; purine; phthalazine; naphthyridine; quinoxaline; quinazoline; phenazine; 1H-indazole; imidazolidine; cinnoline; imidazoline; 1,3,5-triazine; thiazole; pteridine; indazole; 2-ethyl-4-methyl imidazole; any derivative thereof; and any combination thereof.

20. The method of claim 11, wherein the silane coupling agent is selected from the group consisting of N-2-(aminoethyl)-3-aminopropyltrimethoxysilane; 3-glycidoxypropyltrimethoxysilane; gamma-aminopropyltriethoxysilane; N-beta-(aminoethyl)-gamma-aminopropyltrimethoxysilanes; aminoethyl-N-beta-(aminoethyl)-gamma-aminopropyl-trimethoxysilanes; gamma-ureidopropyl-triethoxysilanes; beta-(3-4 epoxy-cyclohexyl)-ethyl-trimethoxysilane; gamma-glycidoxypropyltrimethoxysilanes; vinyltrichlorosilane; vinyltris(beta-methoxyethoxy)silane; vinyltriethoxysilane; vinyltrimethoxysilane; 3-metacryloxypropyltrimethoxysilane; beta-(3,4 epoxycyclohexyl)-ethyltrimethoxysilane; r-glycidoxypropyltrimethoxysilane; r-glycidoxypropylmethylidiethoxysilane; N-beta-(aminoethyl)-r-aminopropyl-trimethoxysilane; N-beta-(aminoethyl)-r-aminopropylmethyldimethoxysilane; 3-aminopropyl-triethoxysilane; N-phenyl-r-aminopropyltrimethoxysilane; r-mercaptopropyltrimethoxysilane; r-chloropropyltrimethoxysilane; vinyltris(beta-methoxyethoxy)silane; r-metacryloxypropyltrimethoxysilane; beta-(3,4 epoxycyclohexyl)-ethyltrimethoxysila; r-glycidoxypropyltrimethoxysilane; r-glycidoxypropylmethylidiethoxysilane; N-beta-(aminoethyl)-r-aminopropyltrimethoxysilane; N-beta-(aminoethyl)-r-aminopropylmethyldimethoxysilane; r-aminopropyltriethoxysilane; N-[3-(trimethoxysilyl)propyl]-ethylenediamine; and combinations thereof.
